(19) United States
(12) Patent Application Publication
(10) Pub. No.: US 2018/0162437 A1
(43) Pub. Date: Jun. 14, 2018

(54) STROLLER WITH CONVERTIBLE CHILD-SUPPORT SYSTEM

(71) Applicant: Dorel Juvenile Group, Inc., Foxboro, MA (US)

(72) Inventor: Marc Mostert, Sittard (NL)

(21) Appl. No.: 15/840,380

(22) Filed: Dec. 13, 2017

(30) Foreign Application Priority Data
Dec. 13, 2016 (FR) 1662390

(51) Int. Cl. B62B 7/12; B62B 9/10

(52) U.S. Cl. CPC B62B 7/123; B62B 9/102

(57) ABSTRACT

A child carrier is adapted to be mounted on a rolling stroller frame to hold a child for transport on the rolling stroller frame. In one mode, the child carrier is configured to provide a bassinet. In another mode, the child carrier is configured to provide a seat.

### PRIORITY CLAIM

This application claims priority to French Patent Application No. 1662390, filed Dec. 13, 2016, which is expressly incorporated by reference herein.

### BACKGROUND

The present disclosure relates to child carriers, and particularly to a juvenile stroller including a child carrier. More particularly, the present disclosure relates to a child carrier that is convertible to function as a bassinet or a seat at the option of a caregiver.

### SUMMARY

According to the present disclosure, a juvenile stroller includes a rolling stroller frame and a child carrier. The child carrier is coupled to the rolling stroller frame to move therewith.

In illustrative embodiments, the convertible child carrier is configured to change between a bassinet mode and a seat mode at the option of a caregiver. The convertible child carrier includes a carrier frame coupled to the rolling stroller frame and a support deck configured to move relative to the carrier frame between a flat orientation associated with the bassinet mode and an upright orientation associated with the seat, and a suspension system arranged to extend between and interconnect the carrier frame and the support deck.

In illustrative embodiments, the suspension system is configured to provide means for imparting relative movement to the carrier frame and the support deck to cause the support deck to lie in a generally horizontal base plane when the convertible child carrier is in the bassinet mode and to cause a portion of the support deck to extend upwardly at angle when the convertible child carrier is changed to the seat mode so that the convertible child carrier is arranged depending on the needs of the child to lie down or sit upright.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a partial perspective view of a first embodiment of a convertible child carrier in accordance with the present disclosure showing the convertible child carrier configured to function as a seat that can be mounted to a stroller frame as suggested in FIG. 4B;

FIG. 2A is a side elevation view of the convertible child carrier of FIG. 1 configured as the seat;

FIG. 2B is a view similar to FIG. 2A showing the convertible child carrier of FIGS. 1 and 2A reconfigured, at the option of a caregiver, to function as a bassinet;

FIG. 3A is a partial top perspective view of the convertible child carrier of FIGS. 1-2B showing the convertible child carrier configured as the seat;

FIG. 3B is a partial bottom perspective view of the convertible child carrier of FIG. 3A;

FIG. 4A is a partial perspective view of a stroller showing that the stroller includes a stroller frame and a second embodiment of a convertible child carrier in accordance with the present disclosure configured as a bassinet;

FIG. 4B is a partial perspective view of the stroller of FIG. 4A with the convertible child carrier reconfigured as a seat;

FIG. 5 is a diagrammatic view of a convertible child carrier in accordance with the present disclosure suggesting hos the convertible child carrier may reconfigured at the option of a caregiver between the bassinet and the seat;

FIG. 6 is a diagrammatic view showing another embodiment of a convertible child carrier showing that the convertible child carrier includes soft goods which are arranged to extend around and partly enclose a first juvenile-receiving space formed in the convertible child carrier when arranged as the bassinet;

FIG. 7 is a partial diagrammatic and perspective view of the convertible child carrier of FIG. 6 configured as a seat showing that the a portion of the soft goods is folded back and arranged to lie behind a leg rest of the convertible child carrier;

FIG. 8 is a view similar to FIG. 7 showing the convertible child carrier reconfigured as the bassinet and showing the portion of the soft goods deployed so as to enclose a portion of the first juvenile-receiving space;

FIG. 9 is a diagrammatic and perspective view of another embodiment of a convertible child carrier arranged as a bassinet and suggesting how side panels included in soft goods of the convertible child carrier are deployed to define a first juvenile-receiving space formed in the convertible child carrier when arranged as the bassinet;

FIG. 10 is a view similar to FIG. 9 showing the convertible child carrier arranged as a seat and suggesting how the side panels have moved to define a second juvenile-receiving space formed in the child carrier when arranged as the seat; and

FIG. 11 is a side elevation view of a stroller including another embodiment of a convertible child carrier in accordance with the present disclosure showing the convertible child carrier includes a movable restraint bar.

### DETAILED DESCRIPTION

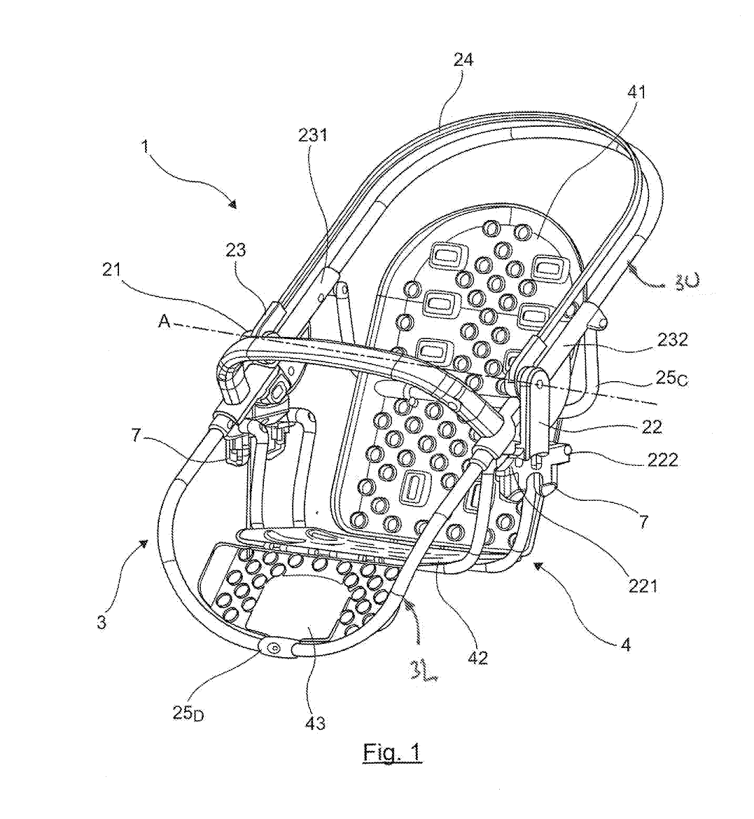

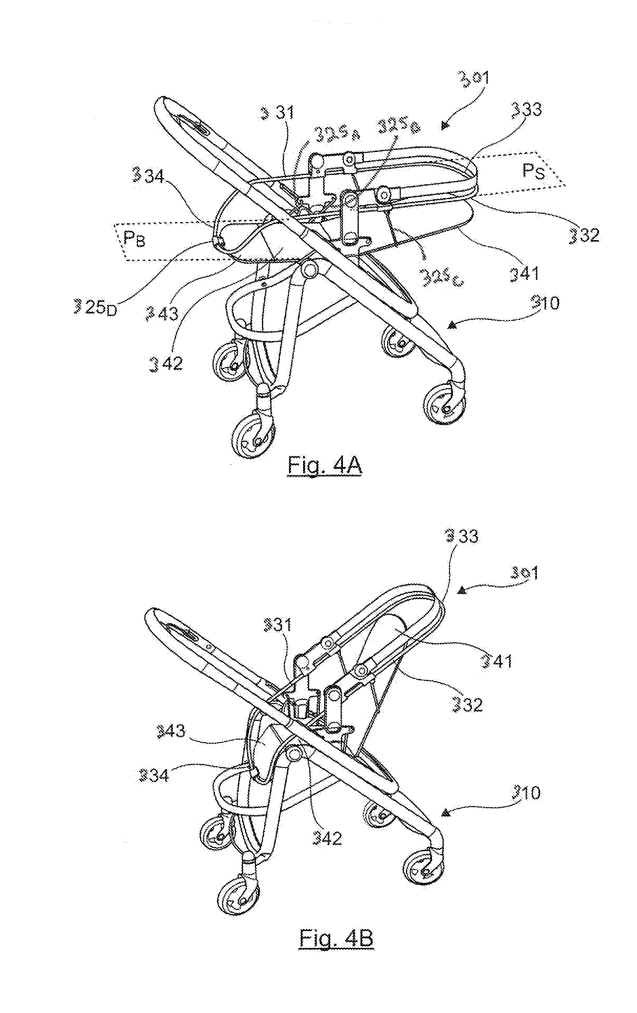

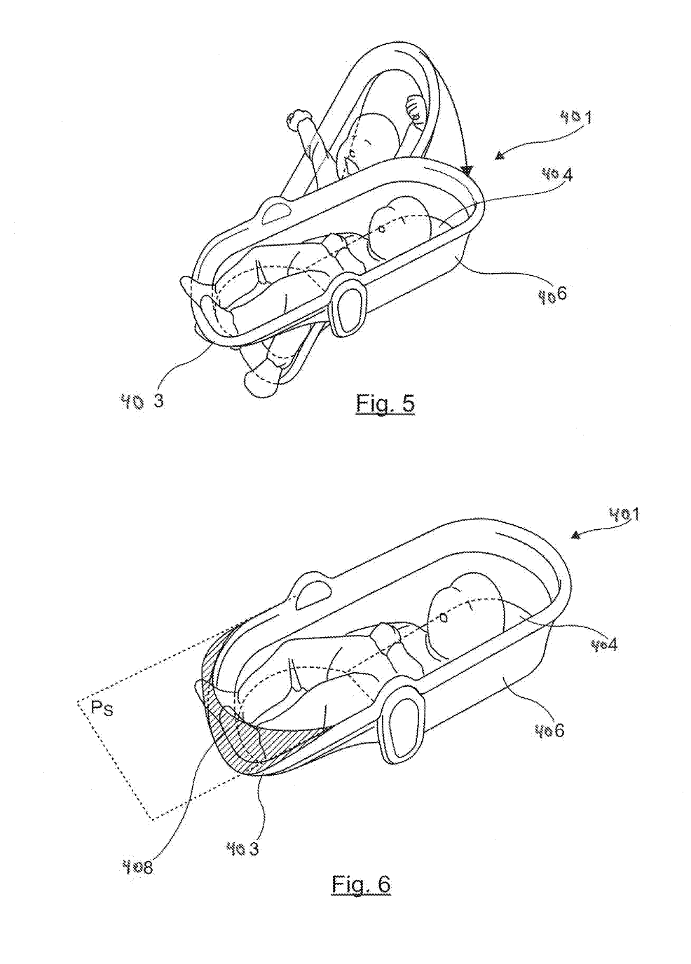

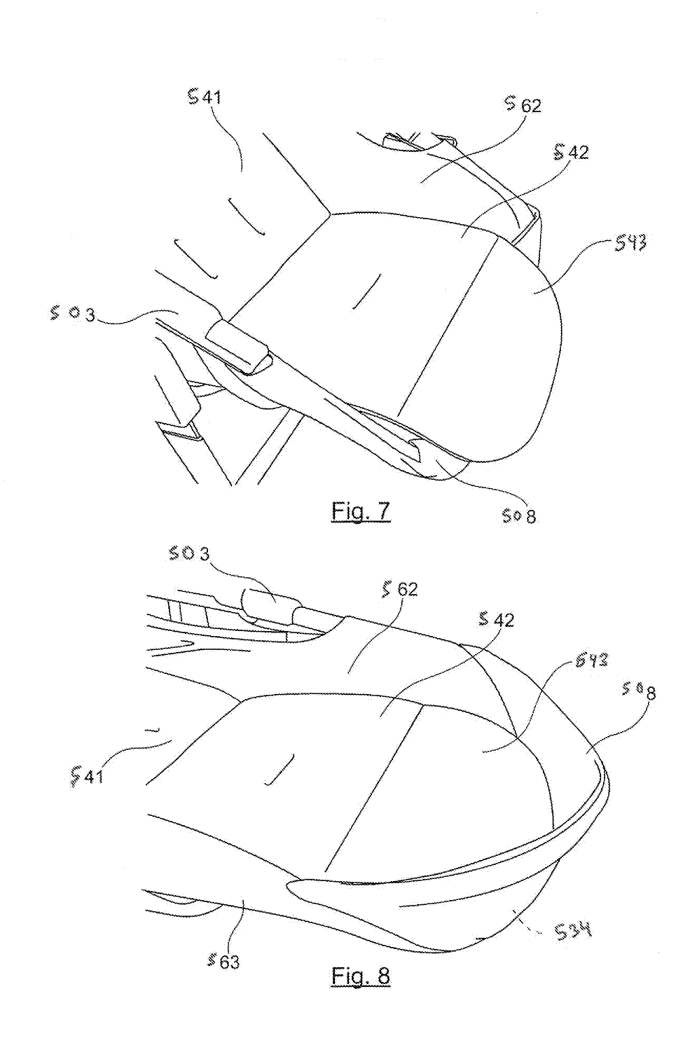

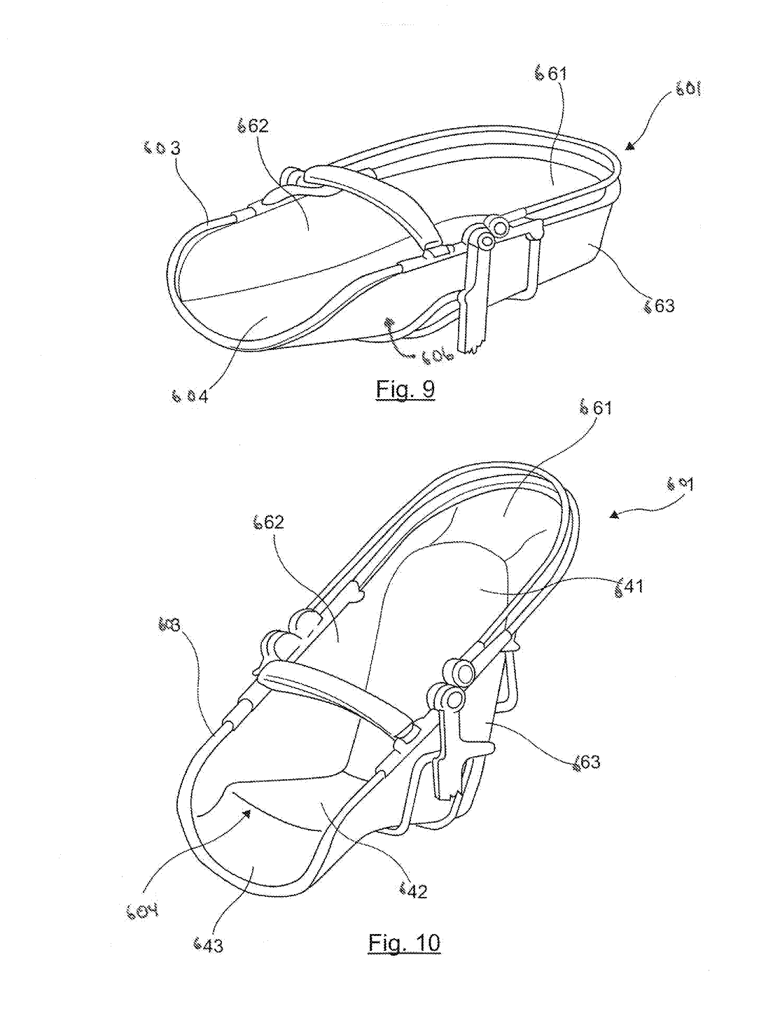

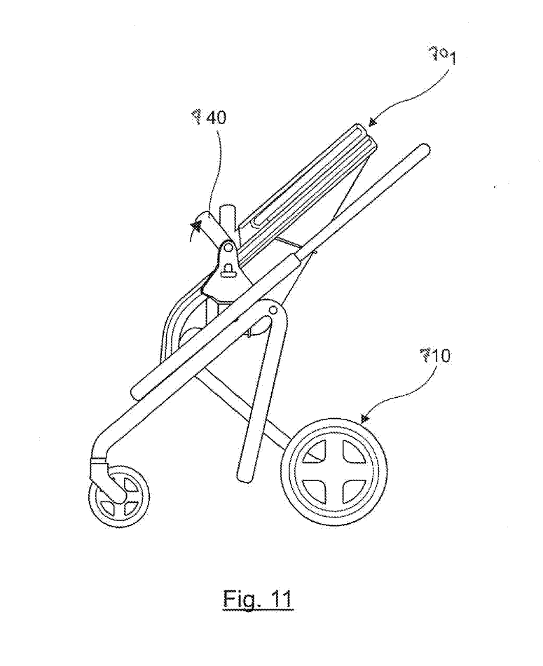

A first embodiment of a convertible child carrier 1 in accordance with the present disclosure is shown in FIGS. 1-3B. Convertible child carrier 1 is coupled to a stroller frame 10 and arranged as a seat or as a bassinet at the option of a caregiver. A second embodiment of a convertible child carrier 301 in accordance with the present disclosure is shown in FIGS. 4A and 4B. A third embodiment of a convertible child carrier 401 in accordance with the present disclosure is shown in FIGS. 5 and 6. A fourth embodiment of a convertible child carrier 501 is shown in FIGS. 7 and 8. A fifth embodiment of a convertible child carrier 601 is shown in FIGS. 9 and 10. A sixth embodiment of a convertible child carrier 701 is shown in FIG. 10.

A convertible child carrier, also called convertible support, is changed between a laid-back position and at least one seated position. The convertible child carrier is mounted, for example, on a stroller frame, also called children's pushchair. In some examples, the convertible child carrier may also be mounted to a fixed frame such as a high chair. The tilting of a frame of the convertible support drives the move from a laid-back position to at least one seated position, and vice-versa, thanks to the specific shape of the frame.

The convertible support of the present disclosure may take on two different positions adapted to suit different moments in the life of the child: a first laid-back position allowing the child to be laid down while being carried in the pushchair, for example in order to sleep; at least one second seated position allowing the child to sit up and interact with his/her surroundings. In certain embodiments, it is possible to provide a plurality of seated positions, corresponding to different inclinations. When the convertible support is in the laid-back position, a bassinet is provided for the child. When the convertible support is in the seated position, a seat is provided for the child.

In the laid-back position, the elements forming the support for receiving the child (i.e. three elements respectively forming a backrest, a seat base, and a leg rest in the seated position) are aligned in a generally horizontal plane, also called a base plane. The frame of the convertible support is located in spaced-apart relation above the base plane and is generally parallel to the base plane.

The frame of the convertible support may be tilted, in order to move the support from the laid-back position into the seated position. The support moves from a position in which it substantially forms a pram into a position in which it substantially forms a buggy. This frame includes two frame uprights providing two lateral edges and two frame crosspieces providing bottom and top end edges. One frame crosspiece is arranged adjacent feet of a child and the other frame crosspiece is arranged adjacent head of the child.

In practice, the different elements constituting the frame (uprights and crosspieces) may be formed in one piece, for example they can be tubular. The connections between the uprights may be at a right angle or can be progressive, in the form of curved parts. Similarly, the uprights and the crosspieces are not necessarily rectilinear, but can be curved or can have a plurality of curves. In one example, the crosspieces can define arcs of a circle, ellipse, or hyperbola. In one other example, the bottom crosspiece is coupled to the leg rest such that it lies in the same plane as the leg rest (i.e. in the base plane), when in the laid-back position.

The frame uprights each have two separate portions, i.e. a main portion situated on the side nearest the backrest and seat base portion and a final portion situated on the side nearest the leg rest portion. In the laid-back position, the main portion of the uprights extends generally horizontally from the top crosspiece, i.e. in the upper plane of the frame. The final portion extends downwards from the main portion according to an angle of less than 180°. The final portions of the uprights come together at the level of the bottom crosspiece of the frame such that the bottom crosspiece lies substantially in the base plane. In the embodiment shown, the connection between the two portions is formed by a curve of the upright. In another embodiment, the two portions can be separate parts.

The first embodiment of a convertible support 1 is shown, for example, in FIG. 1. Convertible support 1 comprises two main lateral fastening uprights 21, 22 that are substantially vertical (i.e. perpendicular to the ground), which support an assembly for receiving the child, formed from a frame 3 and a bottom 4 constituted of three hinged portions in pairs, respectively corresponding, when in a seated position, to a backrest 41, a seat base 42 and a leg rest 43.

The backrest 41 has a length that is substantially equal to the combined length of the seat base 42 and the leg portion 43. The backrest 41 and the seat base 42 represent nearly 3/4 of the total length of the supporting elements.

The vertical fastening uprights 21, 22 each have, in the upper end thereof, a pivot link, pivoting about a first axis A, with a structural element 23 supporting the frame 3. In FIG. 1, structural element 23 has one or more (for example two) regions 231, 232 at which it is coupled to the frame 3, forming for example tubes in which the uprights of the frame run, in order to join the frame 3 to structural element 23. In some embodiments, the functions, or at least some thereof, of the structural element may be performed directly by the frame.

The structural element 23 is also connected via a pivot link arranged to pivot about the same axis A, with a supporting arch 24 of a canopy (not shown), allowing the deployment of the canopy to be varied between a folded position and a deployed position. In another example, the axis A and the rotational axis of the canopy may be different, such that the element 23 and the arch 24 have different rotational axes relative to the lateral fastening uprights 21, 22.

Aside from the canopy, other elements may be mounted in rotation on the elements 23 (for example a protective device and/or a tray intended to receive the child's toys or a drink, called a child tray.

As shown in FIG. 11, a convertible support 701 is coupled to stroller frame 710. The convertible support 701 includes a movable restraint bar, also called a protective device 740. The protective device may be a crash pad or a bumper bar as shown in FIG. 11. The movable restraint bar, for example, may be coupled to the structural element 23 as suggested in FIG. 1. The protective device 740 is arranged to extend laterally across and above the convertible support 701 in the same manner as a shield. The device may also be mounted such that it rotates relative to the chassis of the pushchair, for example, on the lateral fastening uprights 21, 22.

Each of the vertical fastening uprights 21, 22 further comprises two transverse coupling elements 211, 212, 221, 222 extending on either side of the upright, forming a horizontal coupling crosspiece.

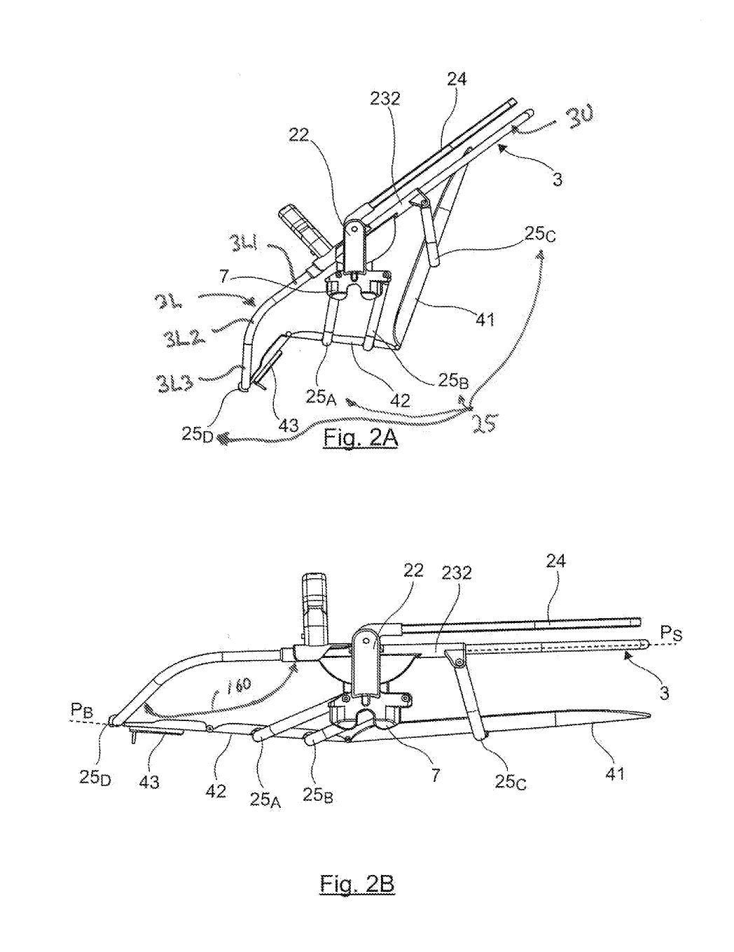

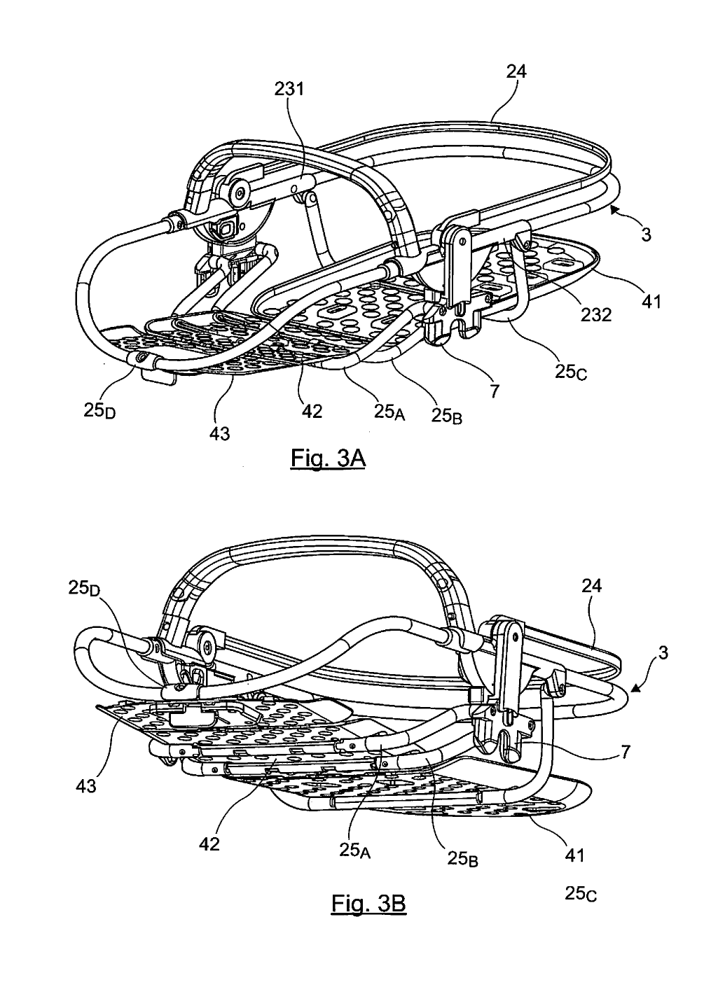

A supporting element 25_{A}, 25_{B} for supporting the seat base 42, or suspension means, is mounted at the end of each coupling element, the base of which suspension means extends beneath the seat base. Suspension means 25_{A}, 25_{B} are particularly visible in FIGS. 2A, 2B, 3A and 3B.

Seat base 42 is thus supported by two suspension means 25_{A}, 25_{B}. The two suspension means 25_{A}, 25_{B} are arranged in spaced-apart longitudinal relationship to one another and are arranged to lie substantially parallel to each other. As shown, for example, in FIG. 2A, the suspension means 25_{A} is relatively shorter than the suspension means 25_{B} in order to slightly incline the seat base in the position in FIG. 2A), substantially forming with the seat base and the transverse coupling elements 221, 222 a deformable parallelogram.

A third suspension means 25_{C}, used to support the backrest 41, is coupled to the frame 3 and positioned in order to support the backrest 41 in the central part thereof. These three suspension means 25_{A}, 25_{B}, 25_{C} are mounted beneath the portions of the seat base 42 and of the backrest 41 respectively, for example using hems and/or connectors allowing for the support and rotation thereof. The suspension means 25_{C} is hinged at the level of the upper frame, to the element 23 supporting the frame. However, the suspension means 25_{A}, 25_{B} are not hinged at the level of said upper frame 3, but in an intermediate position defined by the coupling elements.

The suspension means 25_{A}, 25_{B}, 25_{C} are each formed from folded tubes, defining a U shape, the two branches of which provide a connecting rod function and the base of which runs beneath the seat base, and respectively the backrest (in FIG. 1, the rear part of said tubes has been retracted for easier reading). In another example, the suspension means may also have two connecting rods, each of which is secured to one edge of the seat base without any part extending beneath the seat base.

The leg rest portion 43 is also connected to the frame 3 via a pivot link 25_{D} formed in this instance by a central hinged joint placed at the end of and externally to the leg rest portion 43. In this example, there is no fourth suspension means for the portion which is coupled directly to the frame, and more specifically, to the bottom crosspiece thereof. The three suspension means 25_{A}, 25_{B}, 25_{C}, and the pivot link 25_{D}, for example, provide the only points of contact between the frame 3 and the bottom 4.

Another embodiment of a convertible support 301 is shown in FIGS. 4A and 4B. Convertible support 301 is coupled to a stroller frame 310, also called a pushchair 10. The convertible support 301 is secured onto the chassis of the pushchair 310 by means of a pair of lateral connecting elements 307, for example of the Modulo clip type available from BEBE COMFORT.

In the example shown, such a pushchair 310 comprises two front uprights provided with a pair of front wheels, two rear uprights provided with a pair of rear wheels, and a handle that slides relative to the front uprights. However, any type of pushchair, and more broadly speaking, any type of perambulators may be used with the support of the present disclosure, provided that they are equipped with means for connecting to said convertible support.

The convertible support 301 may therefore take on two respective positions: a first so-called laid-back position, in which the child is substantially laid down and at least one second so-called seated position in which the child is substantially sitting up. One example of the laid-back position is shown in FIG. 4A. In this position, the backrest 341, the seat base 342 and the leg rest 343 are generally aligned in a plane, called the base plane P_{B}, which is generally horizontal. Base plane P_{B} is located at approximately the height of the elements 305 for connecting to the chassis of the pushchair 310. The alignment of the backrest 341, the seat base 342, and the leg rest portion 343 in base plane P_{B} provides a relatively flat surface allowing a child to lie down.

The peripheral frame 303 of the convertible support extends above base plane P_{B}, which peripheral frame defines the contours of the support. A majority portion thereof (about ¾ of the length thereof) extends parallel to the base plane P_{B} in a so-called upper plane P_{S}. A first portion of the frame 303 situated substantially above the backrest 341 and the seat base 342 in the laid-back position, is placed in the upper plane P_{S}. A second portion of the frame 303 is situated substantially above the leg portion 343 in the laid-back position leaves the upper plane P_{S} to join the base plane P_{B}.

More specifically, the frame 303 comprises two lateral edges 331, 332, or uprights, one upper end edge 333, or top crosspiece, and one lower end edge 334, or bottom crosspiece. The uprights 331, 332 are formed from two portions defining an angle a therebetween that is strictly less than about 180°. In one example, this angle lies in the range of about 150° to about 170°. A first so-called main portion (approximately ¾ of the length of the uprights) is situated substantially above the backrest 341 and the seat base 342 in the laid-back position. A second so-called final portion (approximately ¼ to ⅕ of the length of the uprights) is situated substantially above the leg rest portion 343 in the laid-back position.

The top crosspiece 333 and the main portion of the lateral edges 331, 332 are situated in the upper plane P_{S}. The final portion of the lateral edges 331, 332 leaves the upper plane P_{S} and is inclined towards the base plane P_{B}. The bottom crosspiece 334 of the frame 303 is therefore connected to the leg rest 343 in the base plane P_{B} via the pivot link 25_{D}.

The passage to the seated position, diagrammatically shown in FIG. 5, takes place through the tilting of the frame 403 about the first rotational axis A, via the structural element 423. The pivot link 425_{D} between the frame 403 and the leg rest 443 guides the movement of the different bottom elements 404 (backrest 441, seat base 442, leg rest 443) between the laid-back configuration (FIGS. 2B, 2C, 2D, 4A) and the seated configuration (FIG. 1, 2A, 4B).

Therefore, as shown in FIG. 4B, the elements in the seated position are inclined between each other in order to form a seat base allowing a child to sit up. More specifically, with regard to the laid-back position, the backrest 341 is brought upwards, the leg rest portion 343 is inclined downwards, while the seat base 342 remains generally horizontal or at a slight angle relative to the horizontal.

When tilting the frame 303 (in order to move the support into the seated position), the seat base 342 remains substantially horizontal, while moving towards the lateral fastening uprights and while moving closer to the bottom crosspiece of the frame, guided by the deformable parallelogram constituted by the suspension means 325_{A}, 325_{B}. In the seated position, the seat base 342 lies in a plane that is generally parallel to the base plane P_{B}, however that is situated beneath said base plane P_{B}. The backrest 341 is guided in the movement thereof by the suspension means 325.

The frame 303 may be locked in position. For this purpose, locking means are provided for blocking rotation of the laid-back element 323 relative to the lateral fastening uprights 321, 322. The locking means may be located at the level of the hinged joint between the structural element 323 and the respective upright (for example an external button, for example located at the level of the hinged joint, may allow the user to lock or unlock the frame). This scenario is shown in FIGS. 1 to 3B. They may be displaced to another area of the chassis of the pushchair (for example, the external locking button can be located at the front or rear of the frame).

As shown in FIGS. 5 and 6, the frame 403 and the bottom 404 cooperate to form a mattress-support platform of the convertible support 401. Frame 403 and bottom 404 are connected by an intermediate element, or peripheral skirt 406, that is flexible and/or deformable, for example made of fabric as shown in FIG. 5. The upper contour of the skirt surrounds the tubings of the frame 403, for example by way of a hem. The skirt 406, as a result of the shape thereof and the material used, adapts to the position of the three hinged portions of the bottom 404 (i.e. the backrest 41, the seat base 42 and the leg rest portion 43).

As shown in FIGS. 7 and 8, the frame 503 and the bottom 504 cooperate to form a mattress-support platform of the convertible support 501. Frame 503 and bottom 504 are connected by an intermediate element, or peripheral skirt 506, that is flexible and/or deformable, for example made of fabric as shown in FIG. 5. The upper contour of the skirt surrounds the tubings of the frame 503, for example by way of a hem. The skirt 506, as a result of the shape thereof and the material used, adapts to the position of the three hinged portions of the bottom 504 (i.e. the backrest 541, the seat base 542 and the leg rest portion 543).

Skirt 506 comprises an upper strip of fabric and two lateral strips of fabric 562, 563. When the support is in a laid-back position as shown in FIG. 8, the upper strip of fabric 561 and the lateral strips of fabric 562, 563 are situated in a substantially vertical plane that is perpendicular to the plane of the backrest 541. Therefore, in the laid-back position of the convertible support, they form side walls protecting the head and body of the child.

As shown in FIGS. 9 and 10, the frame 603 and the bottom 604 cooperate to form a mattress-support platform of the convertible support 601. Frame 603 and bottom 504 are connected by an intermediate element, or peripheral skirt 606, that is flexible and/or deformable, for example made of fabric as shown in FIG. 9. The upper contour of the skirt surrounds the tubings of the frame 603, for example by way of a hem. The skirt 606, as a result of the shape thereof and the material used, adapts to the position of the three hinged portions of the bottom 604 (i.e. the backrest 641, the seat base 642 and the leg rest portion 643).

Skirt 606 comprises an upper strip of fabric 661 and two lateral strips of fabric 662, 663. When the support is in a laid-back position as shown in FIG. 9, the upper strip of fabric 661 and the lateral strips of fabric 662, 663 are situated in a substantially vertical plane that is perpendicular to the plane of the backrest 641. Therefore, in the laid-back position of the convertible support, they form side walls protecting the head and body of the child.

When the support 601 moves into a seated position of FIG. 10, and the backrest 641 is brought upright, the upper strip 661 is tensioned, and lies substantially in the extension of the plane of the backrest 641. The lateral strips 662, 663 stretch at the level of the seat base 642 so as to form side walls protecting the body of the child.

FIGS. 6 and 8 show one specific feature of the present disclosure according to which the convertible support 1 may be closed by a removable (and/or retractable) finishing element 508 in the vicinity of the lower end edge 534 of the frame 503.

In another embodiment, the finishing element may have an arch, or potentially a plurality thereof, hinge-mounted onto the uprights of the frame, in the vicinity of the bending point of the uprights (i.e. between the main and final portions). A finishing canvas (this can also be a rigid or partially-rigid element) is secured both on the arch and to the bottom crosspiece or to the final portions of the uprights. The one or more arches allow the canvas of the finishing element to be deployed or folded back in the same manner as a canopy.

In the deployed position thereof (more specifically adopted in the laid-back configuration), the upper end of the finishing element 8 is aligned with the main portion of the uprights 31, 32 substantially in the upper plane P_{S}, as shown in FIG. 8. The finishing element 8 thus deployed forms a wall at the level of the child's feet, allowing said child to be safely carried while lying down.

In the folded or retracted position thereof (which is more specifically adopted in the seated configuration), the finishing element 8 can be removed or the upper end thereof can be lowered in order to be aligned in the base plane P_{B} substantially in contact with the crosspiece. FIG. 7 shows the finishing element 8 in the folded position, beneath the leg rest portion 43. This operation can open up a space so as not to hinder the positioning of the child's feet and/or legs.

A convertible support for a children's pushchair, comprises a frame supporting three elements for receiving a child, hinged in pairs, so as to be able to take on at least a laid-back position and a at least one seated position. In the laid-back position, the frame extends in a substantially horizontal upper plane and the receiving elements are substantially aligned in a generally horizontal base plane so as to receive a child lying down. In the at least one seated position, the receiving elements are positioned so as to respectively define a leg rest, a seat base and a backrest, in order to receive a child sitting up.

The frame includes two lateral frame uprights, one top crosspiece and one bottom crosspiece connecting the frame uprights, and the frame uprights have two portions forming an angle therebetween that is less than about 180°. In the laid-back position, a main portion of the uprights extends substantially horizontally from the top crosspiece, and a final portion extends downwards from the main portion towards the bottom crosspiece, such that the latter substantially extends in the base plane. In the laid-back position, the final portion comprising the bottom crosspiece of the frame (part close to the child's feet) is inclined, relatively to the rest of the frame which is substantially parallel to the base plane formed by the child-receiving elements, towards the leg rest such that the bottom crosspiece lies substantially in the same plane as the latter.

The tilting of the frame, by a user, allows the child-receiving elements to move from the laid-back position to a seated position and vice-versa, by means of the bottom crosspiece of the frame secured to the leg rest. Therefore, the bottom crosspiece of the frame guides the tilting of the leg rest element.

The angle formed on the frame lies in the range of about 150 to about 180° allowing for movement between the laid-back position and the seating position. The leg rest element is hinge-mounted on the bottom crosspiece. The bottom crosspiece supports a single hinged joint in the central position. This provides the assembly formed by the frame and the three receiving elements with at least a first degree of mobility, and in particular makes it possible to guide the leg rest element between the two positions thereof.

The final portion of the frame uprights extends substantially vertically, in the one or at least one seated position. The final portion is therefore generally parallel to the portion for receiving the child's legs. Moreover, the height of this final portion, in the one or at least one seated position, substantially corresponds to the height of the leg portion. These features allow the convertible support to pass from one position to the other by the simple tilting of the frame.

The convertible support comprises a removable and/or retractable finishing element, capable of closing the contour defined in said upper plane by said top crosspiece and said main portions of the frame uprights, in said laid-back position. Therefore, when the finishing element is in a deployed position (corresponding to the laid-back position), the convertible support is entirely closed (forming a pram) and the child is supported the child is blocked from placing his/her hands or feet outside the convertible support.

The finishing element has at least one arch hinge-mounted on the frame uprights, in the vicinity of the connection between the main portion and the final portion thereof. The arch can support a first edge of a finishing canvas, also secured to the bottom crosspiece and/or to the final portions of the lateral uprights. The movement of the hinged arch thus drives the movement of the canvas between two positions, i.e. a top position in which the canvas closes the contour formed by the convertible support in the laid-back position so as to fully enclose the child laid therein, and a bottom position in which the canvas is folded back onto itself, the arch being in contact with the bottom crosspiece, so as to free up a space for the child's feet and/or legs.

The convertible support comprises two vertical, lateral fastening uprights supporting the frame in the upper part thereof, and connectors for fastening to a chassis of a pushchair in the lower part thereof. The convertible support can be quickly and easily installed on the pushchair when necessary.

The fastening uprights carry two suspension means, capable of moving in rotation, which support the seat base and extend parallel to each other. The two suspension means form a parallelogram capable of becoming deformed with the seat base. They serve both to support the seat base and to guide the displacement thereof, in a planar movement, when moving from the laid-back position to the at least one seated position and vice-versa.

Each of the fastening uprights supports a horizontal coupling crosspiece forming a cross with the fastening upright, the suspension means being mounted on the coupling crosspiece, on either side of the fastening upright. The branches of the horizontal crosspiece thus allow the hinge point of each suspension means to be offset with the fastening upright, and thus simultaneously the point of contact of each suspension means with the seat base. The seat base is therefore supported over a larger area (defined by the deformable parallelogram), guaranteeing the stability thereof during the displacement thereof.

The coupling crosspiece extends substantially at an equal distance from the upper plane and the base plane, in the laid-back position. A suspension means of the backrest is hinge-mounted on the frame. This suspension means serves both to support the backrest, and guide the displacement thereof between the laid-back position and the at least one seated position and vice-versa.

The suspension means is hinged relative to the backrest substantially at the middle thereof. The suspension means of the backrest is secured relative to the backrest by the hinged joint. This hinged joint at the center of the backrest serves both to ensure that the backrest is balanced during the movement thereof, and to provide at least one degree of mobility allowing the system to function correctly.

A pushchair comprising the convertible support converts between a laid-back position and at least one seated position as disclosed hereinabove. A pushchair chassis may have a cradle, a carrycot, and/or a buggy seat coupled at the caregiver's option thereto.

Convertible supports converting from the laid-back position into a seat, for a children's pushchair, have been proposed, and comprise an upper frame, mounted such that it pivots on the chassis of the pushchair, and supporting a plurality of hinged portions for receiving the child, defining a surface against which the child rests, the angles between said hinged elements varying depending on the position selected.

In the laid-back position, the upper frame extends horizontally, and supports a surface, that is also horizontal, on which a child can be placed lying down. This surface is therefore formed from a plurality of hinged portions, connected to the upper frame via straps or suspension means. In order to move the support into the seated position, and vice-versa, the upper frame is tilted, and suspension means adapts automatically under the effect of the tilting and/or through an adjustment made by the user. The different portions thus respectively form the backrest, seat base and leg rest of a seat on which the child can be placed in the seated position.

A convertible support 1 for a children's pushchair, comprises a frame 3 supporting three elements for receiving a child, hinged in pairs, in order to be able to take on at least two positions:

a laid-back position, in which said frame 3 extends in a generally horizontal upper plane P_{S} and said receiving elements are aligned in a generally horizontal base plane P_{B}, so as to receive a child lying down;

at least one seated position, in which said receiving elements are positioned so as to respectively define a leg rest element 43, a seat base 42 and a backrest 41, in order to receive a child sitting up,

the frame 3 having two lateral frame uprights 31, 32, one top crosspiece 33 and one bottom crosspiece 34 connecting the frame uprights 31, 32, and the frame uprights 31, 32 having two portions forming an angle (α) therebetween that is less than about 180°, such that, in the laid-back position, a main portion of said uprights 31, 32 extends generally horizontally from the top crosspiece 33, and such that a final portion extends downwards from said main portion towards said bottom crosspiece 34, such that the latter extends in said base plane P_{B}.

Child supports for pushchairs are intended to receive a child to be carried. Child supports may be converted between a laid-back position and a seated position. The laid-back position is suitable for carrying a child lying down while the seated position is suitable for carrying a child sitting up. During the first months of a child's life, the child cannot or finds it difficult to sit up and needs a significant amount of sleep. As a result, the child is carried in a laid-back position, for example in a pram or bassinet. As the child grows, it may become more appropriate to carry the child sitting up. In another example, the child may carried lying down or sitting up, depending on whether the child is asleep or awake.

A juvenile stroller comprises a rolling stroller frame 10 and a convertible child carrier 1. The convertible child carrier 1 is coupled to the rolling stroller frame 10 and configured to change between a bassinet mode (shown in FIG. 2B) and a seat mode (shown in FIG. 2A) at the option of a caregiver. The convertible child carrier 1 includes a carrier frame 3 coupled to the rolling stroller frame 10 to pivot about an axis A relative to the stroller frame 10, a support deck 4 configured to move relative to the carrier frame 3, and a suspension system 25 arranged to extend between and interconnect the carrier frame 3 and the support deck 4.

The suspension system 4 is configured to provide means for imparting relative movement to the carrier frame 3 and the support deck 4 to cause the support deck 4 to lie in a generally horizontal base plane P_{B} when the convertible child carrier 1 is in the bassinet mode and to cause a portion of the support deck 4 to extend upwardly at angle when the convertible child carrier 3 is changed to the seat mode.

The support deck 4 includes a seat base 42 and a backrest 41 coupled to the seat base 41 to move relative to the seat base 41. The backrest 41 moves between a laid-back orientation in which a first angle of about 180 degrees is established between the seat base 42 and the backrest 41 and an upright orientation in which the backrest 41 is arranged to extend upwardly away from the generally horizontal base plane P_{B} so as to establish a second angle of about 90 degrees between the seat base 42 and the backrest 41.

The suspension system 25 includes a first seat support 25_{A} and a second seat support 25_{B} spaced apart from the first seat support 25_{A}. The first seat support 25_{A} is arranged to extend between and interconnect the carrier frame 3 and the seat base 42 to allow the seat base 42 to move relative to the first seat support 25_{A}. The second seat support 25_{B} is arranged to extend between and interconnect the carrier frame 3 and the seat base 42 to allow the seat base 42 to move relative to the second seat support 25_{B}.

The suspension system 25 includes a first seat support 25_{A} and a backrest support 25_{D} spaced apart from the first seat support 25_{A}. The first seat support 25_{A} is arranged to extend between and interconnect the carrier frame 3 and the seat base 42 to allow the seat base 42 to move relative to the first seat support 25_{A}. The backrest support 25_{D} is arranged to extend between and interconnect the carrier frame 3 and the backrest 41 to allow the backrest 41 to move relative to the backrest support 25_{D}.

The support deck 4 includes a seat base 42 and a leg rest 43 coupled to the seat base 42 to move relative to the seat base 42 between a flat orientation in which a first angle of about 180 degrees is establish between the seat base 42 and the leg rest 43 and a recline orientation in which the leg rest 43 is arranged to extend downwardly away from the generally horizontal base plane P_{B}. The suspension system 4 includes a first seat support 25_{A} and a second seat support 25_{B} spaced apart from the first seat support 25_{A}. The first seat support 25_{A} is arranged to extend between and interconnect the carrier frame 3 and the seat base 42 to allow the seat base 42 to move relative to the first seat support 25_{A}. Second seat support 25_{B} is arranged to extend between and interconnect the carrier frame 3 and the seat base 42 to allow the seat base 42 to move relative to the second seat support 25_{B}.

The first seat support 25_{A} is generally parallel to the second seat support 25_{B}. The first seat support 25_{A} has a length that is relatively smaller than the second seat support 25_{B}.

One end of the leg rest 43 is coupled to the carrier frame 3 to pivot about a pivot axis. The pivot axis moves with the carrier frame 3 as the convertible child carrier 1 moves between the bassinet mode and the seat mode.

The carrier frame 3 includes a main portion 3U arranged to extend upwardly away from the axis A and a lower portion 3L arranged to extend opposite the upper portion 3U away from the axis A. The main portion 3U is arranged to lie in an upper plane P_{U} which is spaced apart from and generally parallel to the base plane P_{B} when the convertible child carrier 1 establish the bassinet.

The lower portion 3L of the carrier frame 3 includes a mount section 3L1 coupled to the main portion to move therewith, an angled foot section 3L3 located in spaced-apart relation to the mount section, and a transition section 3L2 arranged to extend between and interconnect the mount section 3L1 and the foot section 3L3. The foot section 3L3 is arranged to extend downwardly away from the mount section 3L1 and interconnect the transition section 3L2 and the support deck 4. In one example, the foot section 3L3 cooperates with the main portion 3U to define an included angle 160 therebetween of less than about 180 degrees. In another example, the angle 160 is in a range of about 150 degrees to about 170 degrees.

A juvenile stroller comprises a rolling stroller frame 10 and a convertible child carrier 1 as shown in FIG. 4A. The convertible child carrier 1 is coupled to the rolling stroller frame 10 and configured to establish at least one of a seat, as shown in FIG. 4B, and a bassinet, as shown in FIG. 4A, at the option of a caregiver.

The convertible child carrier includes a carrier frame 3, a support deck 4, and a suspension system 25. The carrier frame 3 is coupled to the rolling stroller frame 10 to pivot about an axis A relative to the rolling stroller frame 10. The support deck is configured to move relative to the carrier frame 3. The suspension system 25 is arranged to extend between and interconnect the carrier frame 3 and the support deck 4. The suspension system is configured to provide means for coordinating movement of the support deck 4 with movement of the carrier frame 3 when the caregiver causes convertible child carrier 1 to provide the bassinet which has the support deck 4 arranged to lie in a generally horizontal base plane P_{B} to support a child resting on the support deck 4.

The suspension system 25 includes a first support 25_{A} arranged to extend between and interconnect the carrier frame 3 and the support deck 4 and a second support 25_{B} located in spaced-apart relation to the first support 25_{A}. The second support 25_{B} is arranged to extend between and interconnect the carrier frame 3 and the support deck 4. In one example, the first support 25_{A} is generally parallel to the second support 25_{B} and the first support 25_{A} has a length that is relatively smaller than a length of the second support 25_{B}.

The support deck 4 includes a leg rest portion 43 coupled to the carrier frame 3 to pivot relative to the carrier frame 3, a seat base portion 42 coupled to the leg rest portion 43 to pivot relative to the leg rest portion 43, and a backrest portion 41 coupled to the seat base portion 42 to pivot relative to the seat base portion 42. The leg rest portion 43 is arranged to extend through the generally horizontal base plane P_{B} when the convertible child carrier 1 establishes the seat.

The carrier frame 3 includes a main portion 3U arranged to extend upwardly away from the axis A and a lower portion 3L arranged to extend opposite the upper portion 3U away from the axis A. The main portion 3U is arranged to lie in an upper plane P_{U} which is spaced apart from and generally parallel to the base plane P_{B} when the convertible child carrier 1 establish the bassinet.

The lower portion 3L of the carrier frame 3 includes a mount section 3L1 coupled to the main portion to move therewith, an angled foot section 3L3 located in spaced-apart relation to the mount section, and a transition section 3L2 arranged to extend between and interconnect the mount section 3L1 and the foot section 3L3. The foot section 3L3 is arranged to extend downwardly away from the mount section 3L1 and interconnect the transition section 3L2 and the support deck 4. In one example, the foot section 3L3 cooperates with the main portion 3U to define an included angle 160 therebetween of less than about 180 degrees. In another example, the angle 160 is in a range of about 150 degrees to about 170 degrees.

1. A convertible support for a children's pushchair, the convertible support comprising a frame supporting three elements for receiving a child, hinged in pairs, in order to be able to take on at least two positions:
a laid-back position in which the frame is arranged to extend in a generally horizontal upper plane and the receiving elements are aligned in a generally horizontal base plane P_{B} so as to receive a child lying down and
at least one seated position in which the receiving elements are positioned so as to provide a leg rest element, a seat base, and a backrest in order to receive a child sitting up,
wherein the frame includes two lateral frame uprights, a top crosspiece, and a bottom crosspiece connected to the frame uprights and
wherein the frame uprights include two portions forming an angle therebetween that is less than about 180° , such that, in the laid-back position, a main portion of the uprights is arranged to extend generally horizontally from the top crosspiece and a final portion is arranged to extend downwardly from the main portion towards the bottom crosspiece to cause the final portion to extend into the base plane.

2. The convertible support of claim 1, wherein the leg rest element is coupled to the bottom crosspiece to pivot relative to the bottom crosspiece.

3. The convertible support of claim 2, wherein the bottom crosspiece supports a single hinged joint in a central position.

4. The convertible support of claim 3, wherein the final portion of the frame uprights is generally vertical when the convertible support is in the at least one seated position.

5. The convertible support of claim 4, further comprising a removable and/or retractable finishing element configured to close a contour defined in the upper plane by the top crosspiece and the main portions of the frame uprights when the convertible support is in the laid-back position.

6. The convertible support of claim 5, wherein the finishing element includes at least one arch hinge-mounted on the frame uprights in the vicinity of a connection between the main portion and the final portion.

7. The convertible support of claim 6, wherein the arch supports a first edge of a finishing canvas which is also coupled to the bottom crosspiece and/or to the final portions of the lateral uprights.

8. The convertible support of claim 1, further comprising two vertical, lateral fastening uprights configured to support the frame in an upper part of the vertical, lateral fastening uprights and connectors adapted to fasten to a chassis of a pushchair in the lower part of the vertical, lateral fastening uprights.

9. The convertible support of claim 8, wherein the vertical, lateral fastening uprights carry two suspension units, the two suspension units are configured to rotate and support the seat base, and the two suspension units are arranged to extend from the vertical, lateral fastening uprights toward the seat base and lie in spaced-apart parallel relations to each other.

10. The convertible support according to claim 9, wherein each of the vertical, lateral fastening uprights supports a horizontal coupling crosspiece and the suspension units are coupled to the coupling crosspiece on either side of the fastening upright.

11. The convertible support of claim 10, wherein the coupling crosspiece is located at about an equal distance from the upper plane and the base plane when the convertible support is in the laid-back position.

12. The convertible support of claim 11, further comprising a suspension unit arranged to extend between and interconnect the backrest and the frame.

13. The convertible support of claim 12, wherein the suspension unit is hinged relative to the backrest at about a middle of the backrest.

14. A pushchair comprising
a convertible support including a frame supporting three elements for receiving a child, hinged in pairs, in order to be able to take on at least two positions:
a laid-back position in which the frame is arranged to extend in a substantially horizontal upper plane and the elements are aligned in a substantially horizontal base plane so as to receive a child lying down thereon and
at least one seated position in which the receiving elements are positioned so as to provide a leg rest, a seat base, and a backrest in order to receive a child sitting up,
wherein the frame includes two lateral frame uprights, one top crosspiece and one bottom crosspiece arranged to connect the frame uprights and
wherein the frame uprights include two portions forming an angle therebetween that is less than about 180°, such that, in said laid-back position, a main portion of the uprights is arranged to extend horizontally from the top crosspiece and a final portion of the frame is arranged to extend downwardly from the main portion toward the bottom crosspiece to cause the final portion to extend into the base plane.

15. A juvenile stroller comprising
a rolling stroller frame and
a convertible child carrier coupled to the rolling stroller frame and configured to change between a bassinet mode and a seat mode at the option of a caregiver, the convertible child carrier including a carrier frame coupled to the rolling stroller frame to pivot about an axis relative to the rolling stroller frame, a support deck configured to move relative to the carrier frame, and a suspension system arranged to extend between and interconnect the carrier frame and the support deck,
wherein the suspension system is configured to provide means for imparting relative movement to the carrier frame and the support deck to cause the support deck to lie in a generally horizontal base plane when the convertible child carrier is in the bassinet mode and to cause a portion of the support deck to extend upwardly at angle when the convertible child carrier is changed to the seat mode.

16. The juvenile stroller of claim 15, wherein the support deck includes a seat base and a backrest coupled to the seat base to move relative to the seat base between a laid-back orientation in which a first angle of about 180 degrees is established between the seat base and the backrest and an upright orientation in which the backrest is arranged to extend upwardly away from the generally horizontal base plane so as to establish a second angle of about 90 degrees between the seat base and the backrest.

17. The juvenile stroller of claim 16, the suspension system includes a first seat support and a second seat support spaced apart from the first seat support, the first seat support is arranged to extend between and interconnect the carrier frame and the seat base to allow the seat base to move relative to the first seat support, and the second seat support is arranged to extend between and interconnect the carrier frame and the seat base to allow the seat base to move relative to the second seat support.

18. The juvenile stroller of claim 16, the suspension system includes a first seat support and a backrest support spaced apart from the first seat support, the first seat support is arranged to extend between and interconnect the carrier frame and the seat base to allow the seat base to move relative to the first seat support, and the backrest support is arranged to extend between and interconnect the carrier frame and the backrest to allow the backrest to move relative to the backrest support.

19. The juvenile stroller of claim 15, wherein the support deck includes a seat base and a leg rest coupled to the seat base to move relative to the seat base between a flat orientation in which a first angle of about 180 degrees is establish between the seat base and the leg rest and a recline orientation in which the leg rest is arranged to extend downwardly away from the generally horizontal base plane.

20. The juvenile stroller of claim 19, the suspension system includes a first seat support and a second seat support spaced apart from the first seat support, the first seat support is arranged to extend between and interconnect the carrier frame and the seat base to allow the seat base to move relative to the first seat support, and the second seat support is arranged to extend between and interconnect the carrier frame and the seat base to allow the seat base to move relative to the second seat support.

21. The juvenile stroller of claim 20, wherein the first seat support is generally parallel to the second seat support and the first seat support has a length that is relatively smaller than the second seat support.

22. The juvenile stroller of claim 19, wherein one end of the leg rest is coupled to the carrier frame to pivot about a pivot axis and the pivot axis moves with the carrier frame as the convertible child carrier moves between the bassinet mode and the seat mode.

23. The juvenile stroller of claim 15, wherein the carrier frame includes a main portion arranged to extend upwardly away from the axis and a lower portion arranged to extend opposite the upper portion away from the axis and the main portion is arranged to lie in an upper plane which is spaced apart from and generally parallel to the generally horizontal base plane when the convertible child carrier is in the bassinet mode.

24. The juvenile stroller of claim 23, wherein the lower portion of the carrier frame includes a mount section coupled to the main portion to move therewith, an angled foot section located in spaced-apart relation to the mount section, and a transition section arranged to extend between and interconnect the mount section and the foot section.

25. The juvenile stroller of claim 24, wherein the foot section is arranged to extend downwardly away from the mount section and interconnect the transition section and the support deck.

26. The juvenile stroller of claim 25, wherein the foot section cooperates with the main portion to define an included angle therebetween of less than about 180 degrees.

27. The juvenile stroller of claim 26, wherein the angle is in a range of about 150 degrees to about 170 degrees.
